(19) United States
(12) Patent Application Publication
(10) Pub. No.: US 2006/0226274 A1
(43) Pub. Date: Oct. 12, 2006

(54) Seat belt retractor

(75) Inventor: Yasuaki Nomura, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/398,597

(22) Filed: Apr. 6, 2006

(30) Foreign Application Priority Data
Apr. 8, 2005 (JP) 2005-111539

(51) Int. Cl. B60R 22/34

(52) U.S. Cl. 242/379.1

(57) ABSTRACT

The disclosed seat belt retractor and seat belt apparatus may effectively suppress vibration and noise occurring in a seat belt retractor so as not to be transmitted to a motor vehicle body. The seat belt retractor may comprise a spool for retracting and withdrawing the seat belt and a base frame for rotatably supporting the spool. The base frame may comprises a first frame for rotatably supporting the spool, a second frame attached to a motor vehicle body, and a cushioning device intervening between the first and second frames.

### BACKGROUND

The present invention relates to the technical field of a seat belt retractor, which is attached to a motor vehicle such as an automobile or the like, which is used for a seat belt apparatus for restraining and protecting an occupant with a seat belt, and which retracts and withdraws the seat belt by means of a spool. More particularly, the present invention relates to a seat belt retractor having a base frame for rotatably supporting the spool and to a seat belt apparatus having the seat belt retractor.

Up to this time, the seat belt apparatus, which is attached to a motor vehicle such as an automobile or the like, restrains an occupant with a seat belt so as to prevent the occupant from moving out of the seat by inertia, thereby protecting the occupant in an emergency such as a vehicle collision where a large deceleration acts on the motor vehicle. The seat belt apparatus is provided with a seat belt retractor that performs the retracting and withdrawing operation for the seat belt and that prevents the seat belt from being withdrawn in the emergency.

Conventionally, a seat belt retractor has been proposed that performs the retracting and withdrawing operations for the seat belt by a motor, e.g., see Japanese PCT Application Publication No. 2003-507252 (hereinafter the “'252 Publication”). In the seat belt retractor disclosed in this publication, an electric motor is disposed coaxially and in series with a belt reel (hereinafter sometimes referred to as a “spool”) at one side of the belt reel in an axial direction so that a rotation of the electric motor is transmitted to the belt reel via a speed-reduction mechanism composed of a planetary gear speed-reduction mechanism at a reduced speed. The belt reel is rotated in a belt retracting direction or a belt withdrawing direction by the rotation of the electric motor, whereby the seat belt can be retracted into or withdrawn from the belt reel.

In a seat belt retractor operated by a motor drive, such as that disclosed in the '252 Publication, because the motor is driven for retracting the seat belt and for withdrawing the same and the speed-reduction mechanism is operated, a vibration and/or a noise tend to occur. In particular, when the spool and the motor are directly connected via the speed-reduction mechanism, because the frequency of the rotation of the spool, the frequency of the motor drive, and the frequency of the operation of the speed-reduction mechanism are increased for the performance of the retracting and withdrawing operations for the seat belt, vibration and noise tend to increase.

In general, the seat belt retractor is disposed in, for example, an internal space of a B-pillar of a motor vehicle body so that the seat belt retractor is not directly exposed in a room of the motor vehicle. However, there are considerable problems in that the above-described vibration or noise is directly transmitted from the seat belt retractor to the motor vehicle body and is further transmitted to the occupants.

Accordingly, the present seat belt retractor is made in light of the above-described problems, and the object of the present application is to provide a seat belt retractor capable of efficiently suppressing vibration or noise, which is caused by the seat belt retractor and transmitted to the motor vehicle body.

Another object of the present application is to provide a seat belt apparatus capable of effectively suppressing the vibration or the noise, which is caused by the seat belt retractor and is transmitted to the occupant.

### SUMMARY

To solve the above-mentioned problems, a seat belt retractor according to one embodiment of the present invention may be characterized in that is includes at least: a seat belt, a spool for retracting and withdrawing the seat belt, and a base frame for rotatably supporting the spool. The base frame may include a first frame for rotatably supporting the spool, a second frame attached to a motor vehicle body, and a cushioning device intervening between the first and second frames.

The seat belt retractor according to another embodiment of the present invention is characterized in that the cushioning device is formed from a cushioning member.

Yet another embodiment of the seat belt retractor of the present disclosure is characterized in that the first frame may include a pair of a flat-plate-shaped first supporting member and a flat-plate-shaped second supporting member for rotatably supporting the spool and a spacing member for coupling the first supporting member and the second supporting member to be spaced at a predetermined distance. The spacing member is a member for setting the first supporting member and the second supporting member to be in parallel with each other.

The seat belt retractor in another embodiment is characterized in that at least one of the spacing member and the pair of the first and second supporting members includes an engaging portion and at least the other of the spacing member and the pair of the first and second supporting members includes an engaged portion to be engaged with the engaging portion.

The seat belt retractor may be characterized in that it can include a motor for generating a rotation drive force to rotate the spool and a speed-reduction mechanism for transmitting the rotation drive force to the spool. In addition, the motor and the speed-reduction mechanism can be supported by the first frame.

Also, a seat belt apparatus can be characterized in that is may include at least a seat belt for restraining an occupant, a seat belt retractor for withdrawably retracting the seat belt, a tongue being slidably supported by the seat belt, and a buckle for the tongue to be detachably engaged therewith. The seat belt retractor can be the seat belt retractor according to any of the embodiments of the present application

Because the base frame can be divided between the first frame for supporting the spool and the second frame to be attached to the motor vehicle body and the first and second frames are coupled with each other via a cushioning devices, vibration and/or noise that are caused by the rotation of the spool can be effectively cut off and suppressed so as not to be transmitted to the motor vehicle body.

In particular, because the cushioning device, for example, can be formed from a cushioning member, such as rubber or the like, the structure of the seat belt retractor is simplified.

In addition, because the first frame, for example, is formed by coupling a pair of flat-plate-shaped first and second supporting members by a spacing member and the first and second supporting members are set in parallel with each other by the spacing member, the degree of parallelization of the first and second supporting members can be obtained with high accuracy. As a result, the assembling accuracy of the spool can be improved. Therefore, the vibration and the noise caused by the rotation of the spool can be further suppressed.

Furthermore, because the first and second supporting members in one embodiment can be coupled in a state such that either one of an engaging portion and an engaged portion formed at the spacing member is engaged with either one of the other engaging portion and the other engaged portion formed at the pair of the first and second supporting members, the first and second supporting members can be firmly coupled with each other and a mutual displacement of the first and second supporting members caused by a load exerted to the spool can be securely prevented.

Because the degree of parallelization of the above-described first and second supporting members can be obtained with high accuracy and/or because the mutual displacement of the first and second supporting members can be prevented, the spool can be supported by the first and second supporting members with high accuracy. Thus, the vibration and the noise, which is caused by the rotation of the spool, can be effectively suppressed.

In addition, according to another embodiment of the seat belt retractor, the transmission of the vibration and the noise, which is caused by the rotation drive of the motor and the operation of the speed-reduction mechanism, to the motor vehicle body can be suppressed. In particular, when the spool is directly connected to the motor via the speed-reduction mechanism, the frequency of drive of the motor and the frequency of the operation of the speed-reduction mechanism are relatively high. However, the transmission of the vibration and the noise to the motor vehicle can be efficiently suppressed by adopting the seat belt retractor of the present application.

Because the degree of parallelization of the first and second supporting members can be obtained by the spacing member with high accuracy, the assembling accuracy of the spool, the motor, and the speed-reduction mechanism can be improved. As a result, the vibration and the noise caused by the rotation of the spool, the drive of the motor, and the operation of the speed-reduction mechanism can be further suppressed. In addition, the rotation drive force of the motor can be efficiently transmitted to the spool with little loss. Thus, the transmission efficiency can be improved, which results in the improvement of the durability of the speed-reduction mechanism.

According to yet another embodiment, because a seat belt apparatus is provided with the seat belt retractor of the present disclosure, the vibration and the noise, which is caused by the seat belt retractor, is cut off to the motor vehicle body. Therefore, the occupant can be prevented from the feeling of being uncomfortable, which is caused by the vibration and/or the noise.

Furthermore, because the first and second frames can be coupled via a cushion device, the impact energy applied to the occupant from a seat belt by the inertia movement of the occupant can be absorbed when a large deceleration acts on the motor vehicle in a case of a vehicle collision or the like and an energy absorbing effect (EA effect) can be obtained by the cushion device.

It is to be understood that both the foregoing general description and the following detailed descriptions are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows a schematic structure of a seat belt apparatus having a seat belt retractor according to one embodiment of the present invention.

FIG. 2 shows a cross-sectional view of a seat belt retractor according to one embodiment of the present invention.

FIG. 3 shows an exploded perspective view of the base frame of the seat belt retractor according to an embodiment of the present invention.

FIG. 4 shows another exploded perspective view of the base frame of the seat belt retractor according to one embodiment of the present invention.

FIG. 5 shows an assembled perspective view of the base frame according to an embodiment of the present invention.

FIG. 6 shows a cross-sectional view along a section line VI-VI in FIG. 2.

### DETAILED DESCRIPTION

Various embodiments of the present invention will be explained with reference to the accompanying drawings.

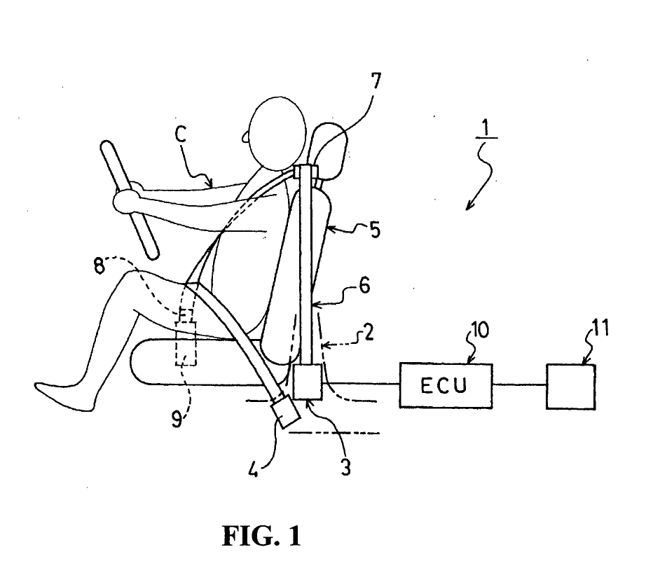

FIG. 1 is a drawing that schematically illustrates a seat belt apparatus having a seat belt retractor according to one embodiment of the present invention. In the explanation below, the directions above, below, left, and right are referred to as that in the drawings used for each of the explanations.

As illustrated in FIG. 1, the seat belt apparatus 1 of this embodiment comprises the seat belt retractor 3, a seat belt 6, a guide anchor 7, a tongue 8, a buckle 9, an electronic control unit (ECU) 10, and an input device 11. The seat belt retractor may be fixed to a B-pillar 2 or the like of a motor vehicle body and is driven by a motor. The seat belt 6 may be withdrawn from the seat belt retractor 3 and may be provided, at its end, with a belt anchor 4, which is fixed to the floor of the motor vehicle body or a motor vehicle seat 5. The guide anchor 7 is attached to a center pillar or the like of the motor vehicle body and guides the seat belt 6 that is withdrawn from the seat belt retractor 3 to a shoulder of an occupant C. The tongue 8 can be slidably supported by the seat belt 6, which is guided from the guide anchor 7. The tongue 8 is inserted into the buckle 9, which is detachably engaged and which is fixed to the floor of the motor vehicle body or the motor vehicle seat 5. The ECU 10 can perform the control operation for the motor of the seat belt retractor 3. The input device 11, such as a collision detection device, an object detection device, or the like, transmits various input signals into the ECU 10 for the ECU 10 to control the electric motor.

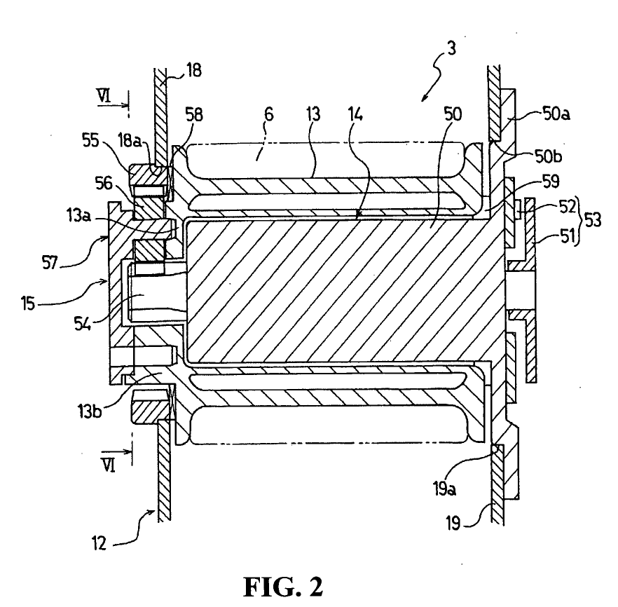

FIG. 2 shows a cross-sectional view schematically illustrating the seat belt retractor of an embodiment of the present invention.

As illustrated in FIG. 2, the seat belt retractor 3 has a base frame 12, a spool 13 for retracting the seat belt 6, an electric motor 14 for rotating the spool 13, and a speed-reduction mechanism 15 for transmitting the rotation drive force of the electric motor 14 to the spool 13 at a reduced speed.

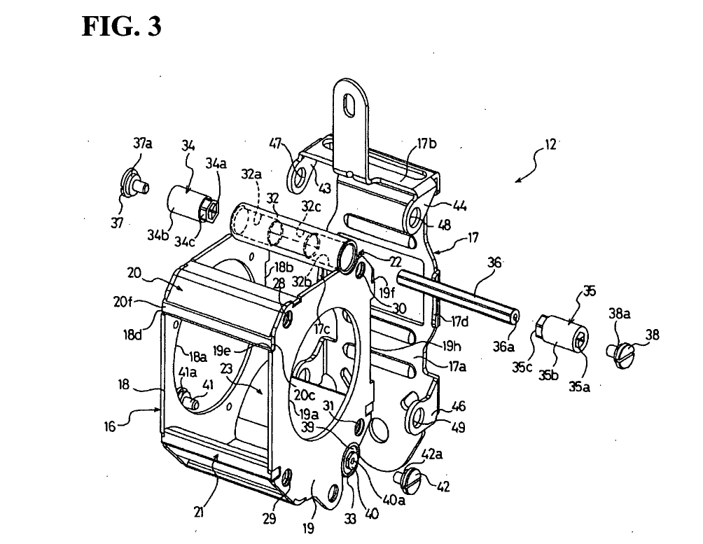

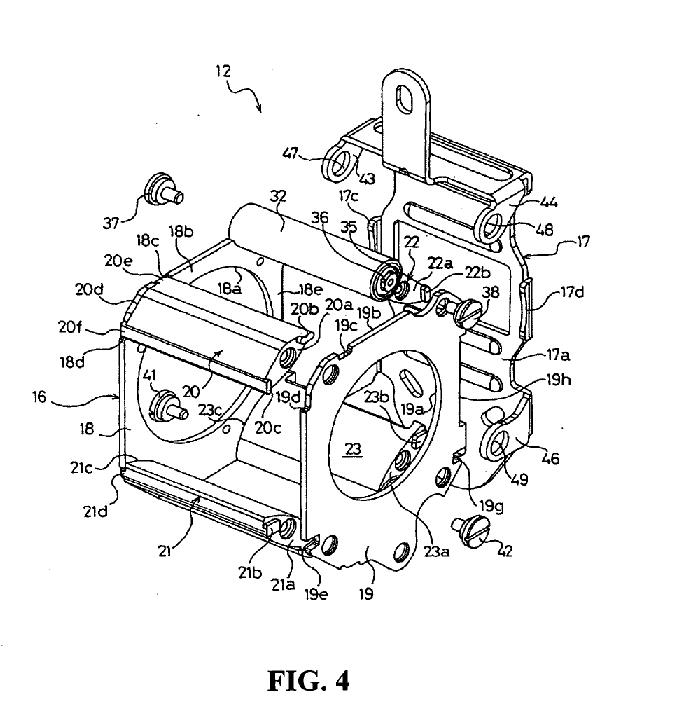

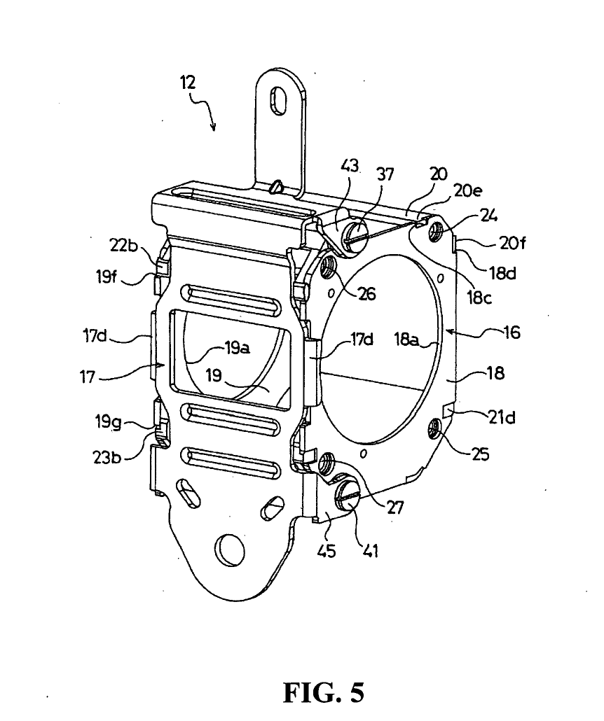

FIG. 3 shows an exploded perspective view of a partially exploded base frame. FIG. 4 is an exploded perspective view of the base frame in which another part of the base frame is exploded. FIG. 5 is an assembled perspective view of the base frame.

As illustrated in FIG. 3, the base frame 12 is formed of a first frame 16 for rotatably supporting the spool 13 and a second frame 17 attached to the motor vehicle body. The first frame 16 is composed of a left-and-right pair of rectangular flat-plate-shaped first and second supporting members 18 and 19 and four spacing members 20, 21, 22, and 23 for coupling the first and second supporting members 18 and 19 at a predetermined distance. In the first and second supporting members 18 and 19, relatively large circular openings 18a and 19a are respectively formed.

As illustrated in FIG. 4, a right end face 20a of the spacing member 20 is in a proximal face-to-face contact with an inside face 19b of the second supporting member 19. In addition, at a right end of the spacing member 20, a pair of engagement projections 20b and 20c are formed. The one engagement projection 20b is engaged with an engagement concave portion 19c of the second supporting member 19 and the other engagement projection 20c is engaged with an engagement step portion 19d of the second supporting member 19. A left end face 20d of the spacing member 20 is in a proximal face-to-face contact with an inside face 18b of the first supporting member 18. In addition, a pair of engagement projections 20e and 20f, which is identical to the pair of the engagement projections 20b and 20c, are formed at a left end of the spacing member 20. The one engagement projection 20e is engaged with an engagement concave portion 18c of the first supporting member 18 and the other engagement projection 20f is engaged with an engagement step portion 18d of the first supporting member 18. Also, a degree of parallelization of the right and left end faces 20a and 20d of the spacing member 20 is specified with high accuracy.

Similarly, the right end face 21a of the spacing member 21 is configured to be in the proximal face-to-face contact with the inside face 19b of the second supporting member 19. At a right end of the spacing member 21, an engagement projection 21b is formed. The engagement projection 21b is engaged with the engagement concave portion 19e of the second supporting portion 19. Furthermore, the left end face 21c of the spacing member 21 is in the proximal face-to-face contact with the inside face 18b of the first supporting member 18. An engagement projection 21d, which is identical to the engagement projection 21b, is formed at a left end of the spacing member 21. The engagement projection 21d is engaged with an engagement concave portion of the first supporting member 18 (formed of the same shape as that of the engagement concave portion 19e). Furthermore, the degree of parallelization of the right and left end faces 21a and 21c of the spacing member 21 is specified with high accuracy.

In the same manner as described above, a right end face 22a of the spacing member 22 is in a proximal face-to-face contact with the inside face 19b of the second supporting member 19. At a right end of the spacing member 22, an engagement projection 22b is formed. The engagement projection 22b is engaged with an engagement step portion 19f (shown in FIG. 3) of the second supporting member 19, which is formed in a similar manner to the engagement step portion 19d. A left end face of the spacing member 22 is in a proximal face-to-face contact with the inside face 18b of the first supporting member 18. In addition, an engagement projection, which is formed similarly to the engagement projection 22b, is formed at a left end of the spacing member 22 (not shown). The engagement projection is engaged with the engagement step portion (formed in such a manner as that of the engagement step portion 18d) of the first supporting member 18. Furthermore, the degree of parallelization of the right end face 22a and the left end face of the spacing member 22 is specified with high accuracy.

In the same manner as described above, a right end face 23a of the spacing member 23 is in a proximal face-to-face contact with the inside face 19b of the second supporting member 19. At a right end of the spacing member 23, an engagement projection 23b is formed. The engagement projection 23b is engaged with an engagement concave portion 19g of the second supporting member 19, which is formed in the same manner as that of the engagement concave portion 19e. The left end face 23c of the spacing member 23 is in a proximal face-to-face contact with the inside face 18b of the first supporting member 18. An engagement projection, which is formed in the same manner as that of the engagement projection 23b, is formed at a left end of the spacing member 23 (not shown). The engagement projection is engaged with an engagement concave portion (formed in the same manner as that of the engagement concave portion with which the engagement projection 21d of the spacing member 21 is engaged) of the first supporting member 18. In addition, the degree of parallelization of both the right end face 23a and the left end face 23c of the spacing member 23 is specified with high accuracy.

Additionally, each of the dimensions of the length between the left end face and the right end face of each of the spacing members 20, 21, 22, and 23 is specified to be equal to each other with high accuracy.

The four spacing members 20, 21, 22, and 23 are connected to the first and second supporting members 18 and 19 by penetrating fixing members, such as bolts (not shown) or the like, through attaching holes 24, 25, 26, and 27, and 28, 29, 30, and 31, which are respectively formed in the first and second supporting members 18 and 19. The first and second supporting members 18 and 19 are screwed to the four spacing members 20, 21, 22, and 23, such that both the left and right end faces of each of the four spacing members 20, 21, 22, and 23 are in a proximal face-to-face contact with each of the inside faces (facing each other) 18b and 19b of the first and second supporting members 18 and 19. The engagement projections provided in the four spacing members 20, 21, 22, and 23 can constitute either one of “one engaging portion” or “one engaged portion” of the present invention. The engagement concave portions and the engagement step portions provided in the first and second supporting members 18 and 19 can constitute either one of “the other engaging portion” or “the other engaged portion” of the present invention.

The four spacing members 20, 21, 22, and 23 are respectively disposed at each of the four corner portions of the first and second supporting members 18 and 19 and they position the first supporting member 18 and the second supporting member 19 at a predetermined distance therebetween. The degree of parallelization of both the right and left end faces of each of the spacing members 20, 21, 22, and 23 is specified with high accuracy. Each of the dimensions of length between the left end face and the right end face of each of the spacing members 20, 21, 22, and 23 is also specified to be equal with high accuracy. Thus, each of the spacing members 20, 21, 22, and 23 specifies the degree of parallelization of the coupled first and second supporting members 18 and 19 with high accuracy. Also, the engagement projections, respectively formed at both the left and right ends of each of the spacing members 20, 21, 22, and 23, are engaged with each of the engagement concave portions and the engagement step portions respectively formed in the first and second supporting members 18 and 19. Thus, each of the spacing members 20, 21, 22, and 23 prevents the coupled first and second supporting members 18 and 19 from being displaced from each other by a load applied to the spool 13. Furthermore, in such a state that the first and second supporting members 18 and 19 are coupled by means of each of the spacing members 20, 21, 22, and 23, the openings 18a and 19a of the first and second supporting members 18 and 19 are disposed in an axial direction keeping high concentricity.

In the upper and lower spacing members 22 and 23, the coupling portions 32 and 33 of the first frame 16 may be each integrally formed, as shown in FIG. 3. Both the coupling portions 32 and 33 of the first frame 16 are extended to approximately the outer faces of the first and second supporting members 18 and 19. A coupling portion 32 of the first frame 16 is located at an upper side and is formed into a cylindrical shape. The inner peripheral faces of both end portions of the coupling portion 32 of the first frame 16 are formed into circular portions 32a and 32b, which have a circular traverse cross-section in which their lengths in an axial direction and their inner diameters are the same to each other. In addition, the circular portions 32a and 32b communicate with each other through an inner peripheral face of a center portion of the coupling portion 32. This inner peripheral face of the center portion is formed into a polygonal portion 32c, whose traverse cross-section may be polygonal, for example, regular hexagonal as shown in FIG. 3. Further, though not shown in the drawings, a coupling portion 33 of the first frame 16 located at a lower side is also formed into the same shape as that of the coupling portion 32 of the first frame 16 located at the upper side.

A pair of cylindrical cushioning members 34 and 35 may be composed of rubber and the like and may have penetration holes 34a and 35a in an axial direction. These penetration holes have a traverse cross-section that is polygonal, for example regular hexagonal as shown in the drawings, and is provided in such a manner so as to be closely fitted into both end portions of the coupling portion 32 of the first frame 16. The cushioning members 34 and 35 are respectively formed of circular portions 34b and 35b that closely fit into the circular portions 32a and 32b. Also, the polygonal portions 34c and 35c closely fit into the polygonal portion 32c and are formed into the same polygon as that of the polygonal portion 32c.

The pair of the cushioning members 34 and 35 can be disposed to be symmetric with each other. The respective polygonal portions 34c and 35c closely fit into the corresponding polygonal portion 32c of the coupling portion 32 of the first frame 16. In addition, the circular portions 34b and 35b of the respective cushioning members 34 and 35 closely fit into the corresponding circular portions 32a and 32b of the coupling portion 32. A reinforcement member 36, whose traverse cross-section has the same polygonal shape as that of the penetration holes 34a and 35a, can be provided in the cushioning members 34 and 35. The cushioning members 34 and 35 are thus attached to the coupling portion 32 of the first frame 16 by being inserted through the penetration holes 34a and 35a in such a manner so as not to be able to rotate relative to the cushioning members 34 and 35. The reinforcement member 36 has a predetermined strength by integrally coupling the pair of the cushioning members 34 and 35 that are separately disposed to each other. Internal threads (only an internal thread 36a at the right end side is shown in FIG. 3) are formed at both end portions of the reinforcement member 36. Fixing members 37 and 38, such as screws, are screwed into the corresponding internal threads.

Similarly, although not shown in the drawings, a pair of cylindrical cushioning members (only a cushioning member 39 at the right side is shown in FIG. 3), a reinforcement member 40 having internal threads at both end portions thereof (only a internal thread 40a at the right side is shown in FIG. 3), and the fixing members 41 and 42 (such as a pair of screws) are provided in the coupling portion 33 of the first frame 16 at the lower side in the same manner as the case of the coupling portion 32.

In a state in which each of the cushioning members 34, 35, 39, etc. is attached to the corresponding upper and lower coupling portions 32 and 33 of the first frame 16, the step portions on the boundaries between the circular portions 34b, 35b, etc. and the polygonal portions 34c, 35c, etc. are in close contact with the step portions on the corresponding boundaries between the circular portions 32a, 32b, etc. and the polygonal portions 32c, etc. In addition, each of the end faces of the circular portions 34b, 35b, etc. at opposite sides of the polygonal portions 34c, 35c, etc. shares approximately the same face with each of the end faces of the coupling portion 32 and 33 of the first frame 16. FIG. 3 only illustrates that the end face of the coupling portion 33 of the first frame 16 at the lower side shares a same face with the end face of the cushioning member 39. Furthermore, in a state in which each of the reinforcement members 36 and 40 is attached to the corresponding upper and lower coupling portions 32 and 33 of the first frame 16, each of the end faces of the reinforcement members 36 and 40 is configured to protrude at a predetermined amount from the end faces of the corresponding cushioning members 34, 35, 39, etc. FIG. 3 only illustrates that the right end face of the reinforcement member 40 protrudes from the right end face of the cushioning member 39.

The second frame 17 is formed into a flat plate shape, i.e., a flat board is formed into a predetermined shape by a press molding process. The second frame 17 is hung across the side ends of the coupling portions 32 and 33 of the first and second supporting members 18 and 19. A pair of the left and right coupling portions 43 and 44 at an upper side and a pair of the left and right coupling portions 45 and 46 (the coupling portion 45 of the second frame 17 is shown in FIG. 5.) at a lower side are provided in the second frame 17. An upper end portion of a main body 17a of the second frame 17 is bent at a right or approximately right angle to form an upper main body 17b. Both the left and right end portions of the upper main body 17b are bent at a right or approximately right angle to form an arm-like shape. Thus, the pair of the coupling portions 43 and 44 of the second frame 17 at the upper side are formed. The pair of the coupling portions 45 and 46 of the second frame 17 at the lower side is formed by bending a lower part of the main body 17a of the second frame 17 at a right or approximately right angle to form an arm-like shape. Circular penetration holes 47, 48, and 49 are formed in the coupling portions 43, 44, and 46 of the second frame 17, as shown in FIG. 3. There is also a penetration hole of the coupling portion 45 of the second frame 17 but it is not shown in FIG. 3. In the penetration holes 47, 48, and 49, the supporting portions 37a, 38a, and 42a of the fixing members 37, 38, and 42, which correspond thereto, are supported in a fitting manner. The supporting shaft 41a of the fixing member 41 is also supported by a penetrating hole (not shown) of the coupling portion 45 of the second frame 17 in a fitting manner.

Now, the assembling process for the thus configured first and second frames 16 and 17 will be explained. First, the coupling portions 43 and 44 of the second frame 17 at the upper side are disposed in such a manner so as to sandwich both ends of the reinforcement member 36 of the first frame 16. The coupling portions 45 and 46 of the second frame 17 at the lower side are disposed in such a manner so as to sandwich both ends of the reinforcement member 40 of the first frame 16. Then, the engaging projections 17c and 17d formed at both the left and right side ends of the main body 17a of the second frame 17 are respectively engaged with the engagement concave portions 18e and 19h, which are formed at the first and second supporting members 18 and 19 of the first frame 16.

Each of the fixing members 37, 38, 41, and 42 is penetrated through each of the penetrating holes of the reinforcement members 36 and 40 and is screwed to each of the internal threads of the reinforcement members 36 and 40. As a result, the coupling portions 43, 44, 45, and 46 of the second frame 17 are supported by the corresponding supporting portions 37a, 38a, 41a and 42a of the fixing members 37, 38, 41, and 42, respectively. Thus, the coupling portions 43, 44, 45, and 46 of the second frame 17 are held between the head portions of each of the fixing members 37, 38, 41, and 42 and both ends of each of the reinforcement members 36 and 40 in a sandwiched manner. As described above, the second frame 17 is integrally combined with the first frame 16 via the coupling portions 43, 44, 45, and 46 of the second frame 17, the reinforcement members 36 and 40, the cushioning members 34, 35, 39, etc., the coupling portions 32 and 33 of the first frame 16, and the spacing members 22 and 23. Thus, the base frame 12 is brought into completion as shown in FIG. 5.

As shown in FIG. 2, the spool 13 may be formed into a cylindrical shape, which is opened at a right end and has a bottom portion 13a at a left end. In the bottom portion 13a, a cylindrical rotation shaft 13b protrudes toward the left and penetrates an opening 18a of the first supporting member 18.

The electric motor 14 can be configured to be a known brush-less motor of an inner-rotor-type. The electric motor 14 may be comprise a cylindrical stator (not shown in FIG. 2) fixed to a portion in a motor housing 50 and may composed of a coil and a rotor that is composed of a magnet that axially extends through and is rotated by the stator. A magnetic disc 51 is provided at a right side of the rotor and is configured to be integrally rotatable with the rotor. Also, a hole sensor 52 is provided in the motor housing 50. In addition, a rotation amount detection sensor 53 for detecting the rotation amount of the electric motor 14 is formed by the magnetic disc 51 and the hole sensor 52. The rotation amount detection sensor 53 can be one of the inputting devices 11. A rotation amount detection signal of the electric motor 14 detected by the rotation amount detection sensor 53 can be inputted into the ECU 10.

An attaching flange 50a is formed at a right end of the motor housing 50. The electric motor 14 is inserted into the spool 13 from the right side in an axial direction. An annular step portion 50b formed at the attaching flange 50a fits into and is supported by the opening 19a of the first supporting member 19. In addition, the attaching flange 50a is fixed to the second supporting member 19 by fixing members (not shown).

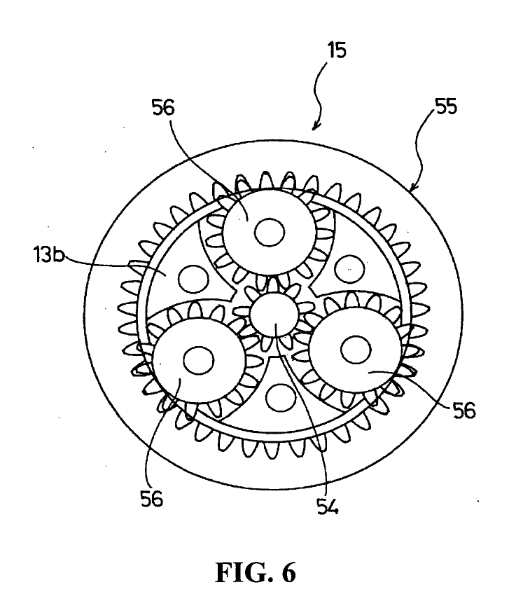

As illustrated in FIGS. 2 and 6, the speed-reduction mechanism 15 is configured to be a planetary gear speed-reduction mechanism. The planetary gear speed-reduction mechanism is disposed at the left end of the rotor of the electric motor 14. The planetary gear speed-reduction mechanism is formed of a sun gear 54 that integrally rotates with the rotor; an internal gear 55 that fits into and is fixed to the opening 18a of the first supporting member 18; a predetermined number (for example, three are shown in FIG. 6) of planetary gears 56 that mesh with both the sun gear 54 and the internal gear 55; and a carrier gear 57 that rotatably supports the planetary gears 56. The carrier gear 57 is attached to the spool 13 and is configured to integrally rotate with the spool 13. The left end side of the spool 13 is supported by the sun gear 54 via the carrier gear 57 and the planetary gears 56 in a radial direction. Furthermore, the spool 13 is rotatably supported by the internal gear 55 at the left end side via a thrust bearing 58 in an axial direction (the thrust direction). The right end side of the spool 13 is supported by the motor housing 50 via a bearing 59 so as to rotate in both the radial and axial directions.

In the thus configured speed-reduction mechanism 15, the rotation of the rotor of the electric motor 14 is transmitted to the planetary gears 56 via the sun gear 54 and the planetary gears 56 rotate. Then, the planetary gears 56 move around the sun gear 54 by its rotation. Thus, the spool 13 is rotated via the carrier gear 57 at a reduced speed. In this case, the ECU 10 performs the control operation for the electric motor 14 to rotate on the basis of the rotation amount detection signal from the rotation amount detection sensor 53.

Thus, in the seat belt retractor 3 of this embodiment, the spool 13 and the electric motor 14 are directly connected via the speed-reduction mechanism 15. The seat belt retractor 3 is configured such that the spool 13 is only rotated by the rotation of the electric motor 14. In this case, the spool 13 is rotated in either a belt retracting direction or a belt withdrawing direction, depending on the rotating direction of the electric motor 14, i.e., a direction of a normal rotation or that of a reversed rotation, which is controlled by the ECU 10. Furthermore, the ECU 10 performs the control operation for the rotation of the electric motor 14 for retracting the seat belt 6 to keep the occupant C under restraint or to store the seat belt 6 or the ECU 10 performs the control operation for the rotation of the electric motor 14 for withdrawing the seat belt 6 to assist the occupant C to withdraw the seat belt 6 when wearing the seat belt 6 on the basis of a resultant input signal from the input device 11 that performs various sensing operations.

According to the seat belt retractor 3 of the present disclosure, because the base frame 12 may be divided between the first frame 16 for supporting the spool 13 and the second frame 17 for attachment to the motor vehicle body and because the first and second frames 16 and 17 are coupled with each other via the cushioning members 34, 35, 40, etc., vibration and noise caused by the rotation of the spool 13, the rotation drive of the electric motor 14, and the operation of the speed-reduction mechanism 15 can be suppressed so as not to be transmitted to the motor vehicle body. In particular, in a case that the spool 13 and the electric motor 14 are directly connected via the speed-reduction mechanism as in the seat belt retractor 3 of FIG. 2, the frequency of the rotation of the spool 13, the frequency of the drive of the electric motor 14, and the frequency of the operation of the speed-reduction mechanism 15 are high for retracting and withdrawing the seat belt 6. Thus, the vibration and the noise to be transmitted to the motor vehicle body can be more efficiently suppressed. In addition, because the cushioning member, such as rubber or the like, may be used for the cushioning device, the structure of the seat belt retractor 3 is simplified.

Further, in the first frame 16 of the base frame 12, because the pair of the flat-plate-shaped first and second supporting members 18 and 19 can be coupled in such a manner so as to be spaced at a predetermined distance by the spacing members 20, 21, 22, and 23 with high accuracy, the degree of parallelization of the first and second supporting members 18 and 19 can be obtained with high accuracy. As a result, the assembling accuracy of the spool 13, the electric motor 14, each of the gears 54, 55, and 56 in the planetary gear speed-reduction mechanism, and the carrier 57 can be improved. Therefore, the vibration and the noise caused by the rotation of the spool 13, the drive of the electric motor 14, and the operation of the speed-reduction mechanism 15 can be further suppressed and the rotation drive force of the electric motor 14 can be efficiently transmitted to the spool 13 with little transmission loss, resulting in the improvement of the transmission efficiency.

Furthermore, each of the engagement projections formed at both the left and right end of each of the spacing members 20, 21, 22, and 23 can be engaged with the engagement concave portions and the engagement step portions provided at the pair of the first and second supporting members 18 and 19. Thus, the first and second supporting members 18 and 19 are coupled with each other by each of the spacing members 20, 21, 22, and 23. Accordingly, the first and second supporting members 18 and 19 can be firmly coupled with each other and the first frame 16 can be provided with high rigidity and firmness. As a result, the mutual displacement between the first and second supporting members 18 and 19 caused by a load applied to the spool 13 can be prevented.

Still further, as described above, because the degree of parallelization of the first and second supporting members 18 and 19 can be obtained with high accuracy and/or because the mutual displacement between the first and second supporting members 18 and 19 can be prevented, the concentricity of the openings 18a and 19a of the first and second supporting members 18 and 19 can be set with a high accuracy. As a result, the concentricity of the spool 13, the electric motor 14, each of the gears 54 and 55 of the speed-reduction mechanism 15, and the carrier gear 57 can be also set with a high accuracy. Accordingly, the vibration and the noise caused by the rotation of the spool 13, the rotation drive of the electric motor 14, and the operation of the speed-reduction mechanism 15 can be further efficiently suppressed. In addition, the durability of each of the gears 54, 55, and 56 of the speed-reduction mechanism 15 can be improved.

In addition, according to the seat belt apparatus 1 of an embodiment of the present invention, because the disclosed seat belt retractor 3 may be provided in the seat belt apparatus 1, the transmission of vibration and noise that occurs in the seat belt retractor 3 is cut off. Thus, the occupant C can be prevented from the feeling of being uncomfortable, which is caused by such vibration and/or noise.

Furthermore, because the first and second frames 16 and 17 can be coupled via the cushioning members 34, 35, 40, etc., the impact energy applied to the occupants C from the seat belt 6 by an inertia movement of the occupant C in an emergency, such as a vehicle collision where a large deceleration acts on the motor vehicle, can be absorbed by the cushioning members. Thus, an EA effect can be obtained by the cushioning members 34, 35, 40, etc.

In addition, although the electric motor 14 can be embedded in the spool 13, the electric motor 14 can also be provided outside the spool 13 along the axial direction of the spool 13, as is described in the '252 Publication. The electric motor 14 can also be provided outside the spool 13 in parallel with the spool 13.

It is natural to mention that the seat belt retractor of the present application is applicable to known seat belt retractors 3 without having the electric motor 14.

The seat belt retractor and the seat belt apparatus having the seat belt retractor of the present application can be used as the seat belt apparatus for protecting the occupants by keeping them under restraint by the seat belt. It can be preferably utilized for the seat belt retractor provided with a base frame that rotatably supports the spool for performing the retracting or withdrawing operations of the seat belt and for a seat belt apparatus having the same.

The priority application Japanese Patent Application No. 2005-111539, filed Apr. 8, 2005, is incorporated by reference herein.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What I claim is:

1. A seat belt retractor comprising:
a spool for retracting and withdrawing a seat belt; and
a base frame for rotatably supporting the spool, and
wherein the base frame comprises:
a first frame for rotatably supporting the spool;
a second frame configured to attach to a motor vehicle body; and
a cushioning device intervening between the first and second frames.

2. The seat belt retractor according to claim 1, wherein the cushioning device is formed from a cushioning member.

3. The seat belt retractor according to claim 1, wherein the first frame comprises:
a pair of flat-plate-shaped first and second supporting members for rotatably supporting the spool; and
a spacing member for coupling the first and second supporting members to be spaced at a predetermined distance, and
wherein the spacing member is a member for setting the first and second supporting members to be in parallel with each other.

4. The seat belt retractor according to claim 3, wherein at least one of the spacing member and the pair of the first and second supporting members comprises an engaging portion, and
wherein at least the other of the spacing member and the pair of the first and second supporting members comprises an engaged portion to be engaged with the engaging portion.

5. The seat belt retractor according to claim 1, further comprising:
a motor for generating a rotation drive force to rotate the spool; and
a speed-reduction mechanism for transmitting the rotation drive force to the spool, and
wherein the motor and the speed-reduction mechanism are supported by the first frame.

6. A seat belt apparatus comprising:
a seat belt for restraining an occupant;
a seat belt retractor including a spool for retracting and withdrawing a seat belt, a first frame for rotatably supporting the spool, a second frame configured to attach to a motor vehicle body, and a cushioning device intervening between the first and second frames;
a tongue configured to be slidably supported by the seat belt; and
a buckle for detachable engagement with the tongue.

7. The apparatus of claim 6, wherein the cushioning device comprises rubber.

8. The apparatus of claim 6, wherein the cushioning device includes penetration holes to accommodate a member positioned to reinforce the first frame.

9. The apparatus of claim 6, further comprising:
a motor for generating a rotation drive force to rotate the spool; and
a speed-reduction mechanism for transmitting the rotation drive force to the spool, and
wherein the motor and the speed-reduction mechanism are supported by the first frame.

10. A seat belt retractor comprising:
a spool for retracting and withdrawing a seat belt; and
a first frame for rotatably supporting the spool, wherein the first frame comprises a reinforcement member;
a plurality of cushioning devices, wherein the reinforcement member is inserted into the cushioning member.

11. The seat belt retractor according to claim 10, further comprising a second frame configured to attach to a motor vehicle,
wherein the cushioning device interferes between the first and second frames.

12. The seat belt retractor according to claim 10, wherein the cushioning device comprises rubber.

13. The seat belt retractor according to claim 10, wherein the reinforcement member has a polygonal cross-section.

14. The seat belt retractor according to claim 13, wherein each cushioning device includes penetration holes of a polygonal cross-section to accommodate the reinforcement member.

15. The seat belt retractor according to claim 10, further comprising:
a motor for generating a rotation drive force to rotate the spool; and
a speed-reduction mechanism for transmitting the rotation drive force to the spool, and
wherein the motor and the speed-reduction mechanism are supported by the first frame.
